(19) United States
(12) Patent Application Publication
(10) Pub. No.: US 2022/0204792 A1
(43) Pub. Date: Jun. 30, 2022

(54) Ink Jet Ink Composition, Ink Jet Ink Set, And Ink Jet Recording Apparatus

(71) Applicant: Seiko Epson Corporation, Tokyo (JP)

(72) Inventor: Kazuki SHIMURA, Shiojiri (JP)

(21) Appl. No.: 17/559,122

(22) Filed: Dec. 22, 2021

(30) Foreign Application Priority Data
Dec. 25, 2020 (JP) 2020-217890

(51) Int. Cl. C09D 11/40; C09D 11/033; C09D 11/328; C09D 11/102; B41M 5/00

(52) U.S. Cl. CPC C09D 11/40; C09D 11/033; B41M 5/0023; C09D 11/102; C09D 11/328

(57) ABSTRACT

An ink jet ink composition contains at least one disperse dye, a silicone surfactant, and water. The disperse dye content is 1.0% by mass or more and 3.0% by mass or less. When 1.0 part by mass of the silicone surfactant and 99.0 parts by mass of a 10% by mass aqueous solution of propylene glycol are mixed to give a mixture, the mixture has a cloud point of 60° C. or above.

The present application is based on, and claims priority from JP Application Serial Number 2020-217890, filed Dec. 25, 2020, the disclosure of which is hereby incorporated by reference herein in its entirety.

### BACKGROUND

### 1. Technical Field

The present disclosure relates to an ink jet ink composition, an ink jet ink set, and an ink jet recording apparatus.

### 2. Related Art

Ink jet recording is a recording process in which droplets of ink are ejected from very thin nozzles and attached to a recording medium. Although only requiring a relatively affordable system, high-resolution and high-quality images are recorded quickly. The factors to consider are numerous, including the nature of the ink(s) used, the stability of the recording process, the quality of the resulting image, and many more. Researchers are enthusiastic about studies not only on recording apparatuses but also inks used therewith.

Ink jet inks containing a disperse dye, in particular, can become contaminated by debris produced by the aggregation or recrystallization of the colorant disperse dye when the dye is of low dispersion stability.

To address this, JP-A-2015-193692 proposes an ink jet ink composition that contains a disperse dye and a sodium naphthalene sulfonate-formaldehyde condensate. The ratio of the concentration of sodium ions to the sodium naphthalene sulfonate-formaldehyde condensate content is in a particular range.

In recent years, however, there has been a need for ink jet ink compositions with further improved storage stability.

To be more specific, whereas ink jet ink compositions with a relatively high disperse dye content achieve relatively high storage stability, those with a relatively low disperse dye content, specifically 3.0% by mass or less, and containing water are not stable enough when stored.

An ink jet recording apparatus, furthermore, tends to store ink jet ink compositions therein for long, for example when its ink tanks are of high capacity. In that case the images produced can have slightly different colors from time to time, for example because solids in the ink jet ink compositions slowly settle down over time.

Some ink jet recording apparatuses may have more than one ink tank for ink jet ink compositions in each single color that can be switched between, for example according to the usage of the ink jet ink compositions. Once the color of images formed by one of these ink jet ink compositions changes due to the sedimentation of solids, the images formed after the ink tank is switched to another will have a seriously different color.

### SUMMARY

The present disclosure was made to address these disadvantages. Its exemplary applications include the following.

According to an exemplary application of the present disclosure, an ink jet ink composition contains at least one disperse dye; a silicone surfactant; and water. A disperse dye content is 1.0% by mass or more and 3.0% by mass or less; and when 1.0 part by mass of the silicone surfactant and 99.0 parts by mass of a 10% by mass aqueous solution of propylene glycol are mixed to give a mixture, the mixture has a cloud point of 60° C. or above.

According to another exemplary application of the present disclosure, the ink jet ink composition further contains at least one dispersant.

According to another exemplary application of the present disclosure, the dispersant in the ink jet ink composition is one or more selected from the group consisting of sodium salts of sulfonated naphthalene-formaldehyde condensates and sodium salts of lignosulfonates.

According to another exemplary application of the present disclosure, the disperse dye in the ink jet ink composition is one or more selected from the group consisting of C.I. Disperse Red 60 and C.I. Disperse Blue 359.

According to another exemplary application of the present disclosure, the disperse dye content of the ink jet ink composition is 2.0% by mass or less.

According to another exemplary application of the present disclosure, a silicone surfactant content of the ink jet ink composition is 0.1% by mass or more and 3.0% by mass or less.

According to an exemplary application of the present disclosure, an ink jet ink set includes a plurality of ink jet ink compositions. At least one of the ink jet ink compositions is the ink jet ink composition according to an exemplary application of the present disclosure.

According to another exemplary application of the present disclosure, two or more of the ink jet ink compositions in the ink jet ink set are the ink jet ink compositions according to an exemplary application of the present disclosure.

According to another exemplary application of the present disclosure, the ink jet ink compositions in the ink jet ink set include at least one light ink being the ink jet ink composition or compositions according to an exemplary application of the present disclosure; and at least one dark ink containing the same disperse dye as the light ink and a higher concentration of the disperse dye than the light ink.

According to another exemplary application of the present disclosure, the dark ink in the ink jet ink set is at least one ink including cyan ink; and a disperse dye content of the cyan ink is 3.5% by mass or more and 6.0% by mass or less.

According to another exemplary application of the present disclosure, the ink jet ink set is such that 0.18≤XLC/XDC≤0.70, where XDC is the disperse dye content in % by mass of the cyan ink, and XLC is disperse dye content in % by mass of the light ink containing the same disperse dye as the cyan ink.

According to another exemplary application of the present disclosure, the dark ink in the ink jet ink set is at least one ink including magenta ink; and a disperse dye content of the magenta ink is 5.0% by mass or more and 8.0% by mass or less.

According to another exemplary application of the present disclosure, the ink jet ink set is such that 0.18≤XLM/XDM≤0.70, where XDM is the disperse dye content in % by mass of the magenta ink, and XLM is disperse dye content in % by mass of the light ink that contains the same disperse dye as the magenta ink.

According to an exemplary application of the present disclosure, an ink jet recording apparatus includes the ink jet ink composition according to an exemplary application of the present disclosure.

### BRIEF DESCRIPTION OF THE DRAWINGS

FIG. 1 is a perspective view of an ink jet recording apparatus according to an embodiment, illustrating an overview of the apparatus.

FIG. 2 is a cross-sectional view of a droplet ejector as a component of an ink jet recording apparatus according to an embodiment, illustrating an overview of the ejector.

FIG. 3 is a perspective view of an ink jet ink composition dispenser according to an embodiment, illustrating an overview of the dispenser.

FIG. 4 is a perspective view of an ink jet ink composition dispenser according to an embodiment, illustrating an overview of the dispenser.

FIG. 5 is a perspective view of an ink jet ink composition dispenser according to an embodiment, illustrating an overview of the dispenser.

FIG. 6 is a perspective view of an ink jet ink composition dispenser according to an embodiment, illustrating an overview of the dispenser.

FIG. 7 is a perspective view of an ink jet ink composition dispenser according to an embodiment, illustrating an overview of the dispenser.

### DESCRIPTION OF EXEMPLARY EMBODIMENTS

The following describes preferred embodiments of aspects of the present disclosure in detail.

### 1. Ink Jet Ink Composition

An aspect of the present disclosure is an ink jet ink composition.

The ink jet ink composition according to this aspect of the disclosure contains at least one disperse dye; a silicone surfactant; and water. The disperse dye content is 1.0% by mass or more and 3.0% by mass or less, and when 1.0 part by mass of the silicone surfactant and 99.0 parts by mass of a 10% by mass aqueous solution of propylene glycol are mixed together, the resulting mixture has a cloud point of 60° C. or above.

By virtue of this, the ink jet ink composition is highly stable when stored. Noticeably, ink jet ink compositions having a relatively low disperse dye content as described above benefit from this. Owing to the high storage stability, furthermore, unwanted changes in the chemical makeup and color of the ink jet ink composition over time, for example, before its ink jet ejection is prevented effectively, making the image formed and the recording produced highly stable and reliable.

Failing to meet the above requirements would make the outcome unsatisfactory. For example, if without a silicone surfactant, the ink jet ink composition would not be highly stable when stored.

If the disperse dye content of the ink jet ink composition were below the lower limit, the color density of the image formed using the ink jet ink composition would not be sufficiently high. The prevention of bleeding and other defects would not be successful enough either.

If the cloud point of the silicone surfactant mixture as described above were below 60° C., furthermore, the ink jet ink composition would not be highly stable when stored.

As mentioned herein, the cloud point of the mixture is that measured as directed in JIS K 2269.

### 1-1. Disperse Dye(s)

The ink jet ink composition according to this aspect of the present disclosure contains at least one disperse dye.

According to this aspect of the present disclosure, the disperse dye in the ink jet ink composition can be of any kind. Specific examples include the following.

Examples of yellow disperse dyes include C.I. Disperse Yellow 3, 4, 5, 7, 9, 13, 23, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 160, 162, 163, 164, 165, 179, 180, 182, 183, 184, 186, 192, 198, 199, 202, 204, 210, 211, 215, 216, 218, 224, 227, 231, and 232.

Examples of orange disperse dyes include C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, and 142.

Examples of red disperse dyes include C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, and 328.

Examples of violet disperse dyes include C.I. Disperse Violet 1, 4, 8, 23, 26, 27, 28, 31, 33, 35, 36, 38, 40, 43, 46, 48, 50, 51, 52, 56, 57, 59, 61, 63, 69, and 77.

Examples of green disperse dyes include C.I. Disperse Green 9.

Examples of brown disperse dyes include C.I. Disperse Brown 1, 2, 4, 9, 13, and 19.

Examples of blue disperse dyes include C.I. Disperse Blue 3, 7, 9, 14, 16, 19, 20, 26, 27, 35, 43, 44, 54, 55, 56, 58, 60, 62, 64, 71, 72, 73, 75, 79, 81, 82, 83, 87, 91, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333, and 359.

Examples of black disperse dyes include C.I. Disperse Black 1, 3, 10, and 24.

The ink jet ink composition according to this aspect of the present disclosure can be made with, for example, one or a combination of two or more selected from these disperse dyes.

In particular, using one or more disperse dyes selected from the group consisting of C.I. Disperse Red 60 and C.I. Disperse Blue 359 makes the advantages of this aspect of the disclosure, described above, more significant.

According to this aspect of the present disclosure, the disperse dye content of the ink jet ink composition only needs to be 1.0% by mass or more and 3.0% by mass or less. Preferably, the lower limit on the disperse dye content of the ink jet ink composition is 1.1% by mass, more preferably 1.2% by mass. It is preferred that the upper limit on the disperse dye content of the ink jet ink composition be 2.0% by mass, more preferably 1.8% by mass.

These make the advantages of this aspect of the disclosure, described above, more significant.

### 1-2. Silicone Surfactant

The ink jet ink composition according to this aspect of the present disclosure contains a silicone surfactant.

According to this aspect of the present disclosure, the silicone surfactant as a component of the ink jet ink composition meets the above cloud point requirement.

A specific example of a suitable silicone surfactant is a compound represented by the formula below:

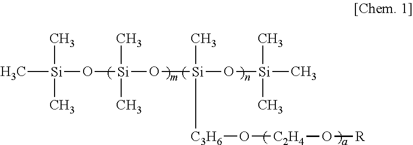

(where R represents a hydrogen atom or methyl group, “a” represents an integer of 2 to 13, m represents an integer of 2 to 70, and n represents an integer of 1 to 8).

According to this aspect of the present disclosure, it is preferred that the silicone surfactant content of the ink jet ink composition be 0.1% by mass or more and 3.0% by mass or less. More preferably, the silicone surfactant content is 0.2% by mass or more and 2.0% by mass or less, even more preferably 0.3% by mass or more and 1.5% by mass or less.

This makes the ink jet ink composition according to this aspect of the present disclosure even more stable when stored.

### 1-3. Water

The ink jet ink composition according to this aspect of the present disclosure contains water.

In the ink jet ink composition, the water plays the primary role as the dispersion medium for the disperse dye.

According to this aspect of the present disclosure, it is preferred that the water content of the ink jet ink composition be 40% by mass or more and 80% by mass or less. More preferably, the water content is 45% by mass or more and 75% by mass or less, even more preferably 50% by mass or more and 70% by mass or less.

This makes it more certain that the viscosity of the ink jet ink composition is in an appropriate range, helping further improve stability in ink jet ejection.

### 1-4. Dispersant(s)

According to this aspect of the present disclosure, the essential components of the ink jet ink composition are at least one disperse dye, a silicone surfactant that meets the requirement set forth above, and water. The ink jet ink composition, however, may further contain at least one dispersant.

This makes the ink jet ink composition according to this aspect of the present disclosure even more stable when stored.

Examples of dispersants include sodium salts of sulfonated naphthalene-formaldehyde condensates, sodium salts of lignosulfonates, the sodium salt of styrene-styrene sulfonate, and sodium salts of formaldehyde condensates of creosote oil sulfonate. Although any one or a combination of two or more selected from these can be used, preferably the dispersant is one or more selected from the group consisting of sodium salts of sulfonated naphthalene- formaldehyde condensates and sodium salts of lignosulfonates.

This makes the above advantage more significant.

According to this aspect of the present disclosure, it is preferred that the dispersant content of the ink jet ink composition be 0.5% by mass or more and 4.0% by mass or less. More preferably, the dispersant content is 0.8% by mass or more and 3.2% by mass or less, even more preferably 1.1% by mass or more and 1.8% by mass or less.

This makes the above advantage more significant.

### 1-5. Water-Soluble Organic Solvent(s)

The ink jet ink composition according to this aspect of the present disclosure may contain at least one water-soluble organic solvent.

This helps improve the water retention of the ink jet ink composition, and improved water retention helps prevent, for example, unwanted separation of solids out of the ink jet ink composition, such as that resulting from drying at an ink jet head or elsewhere, more effectively. The viscosity of the ink jet ink composition, furthermore, is controlled to a more appropriate range. Overall, adding organic solvent(s) enhances the stability of ink jet ejection of the ink jet ink composition.

A water-soluble organic solvent refers to any organic solvent that dissolves in water. For example, organic solvents having a solubility of at least 10 g/100 g in water at 25° C. are suitable.

Preferably, the boiling point of the water-soluble organic solvent at 1 atm is 180° C. or above and 300° C. or below.

This further improves the water retention of the ink jet ink composition, providing even more effective prevention of, for example, unwanted separation of solids out of the ink jet ink composition, such as that resulting from drying at an ink jet head or elsewhere. Using organic solvent(s) with such a boiling point, therefore, makes the stability of ink jet ejection of the ink jet ink composition even better. Organic solvents having such a boiling point, furthermore, can be removed by evaporation with relative ease if necessary after the ejection of the ink jet ink composition; unwanted remaining of water-soluble organic solvent(s) in the recording produced will be prevented more effectively.

Examples of such water-soluble organic solvents include alkyl monoalcohols; alkyldiols; glycerol; glycols; glycol monoethers; and lactams. One or a combination of two or more selected from these can be used.

Examples of glycols include ethylene glycol, diethylene glycol, triethylene glycol, and propylene glycol. Examples of glycol monoethers include triethylene glycol monomethyl ether and triethylene glycol monobutyl ether. Examples of lactams include 2-pyrrolidone.

According to this aspect of the present disclosure, it is preferred that the water-soluble organic solvent content of the ink jet ink composition be 4.0% by mass or more and 45% by mass or less. More preferably, the water-soluble organic solvent content is 9.0% by mass or more and 40% by mass or less, even more preferably 11% by mass or more and 38% by mass or less.

This gives the ink jet ink composition a more appropriate degree of viscosity and helps better improve the water retention of the ink jet ink composition at the same time. As a result, the stability of ink jet ejection of the ink jet ink composition will be even better.

Preferably, XH/XW is 0.10 or more and 0.65 or less, where XW is the water content (% by mass) of the ink jet ink composition, and XH is the water-soluble organic solvent content (% by mass) of the ink composition. More preferably, XH/XW is 0.20 or more and 0.60 or less, even more preferably 0.30 or more and 0.55 or less.

This gives the ink jet ink composition a more appropriate degree of viscosity and helps better improve the water retention of the ink jet ink composition at the same time. As a result, the stability of ink jet ejection of the ink jet ink composition will be even better.

### 1-6. Extra Ingredients

The ink jet ink composition according to this aspect of the present disclosure may contain ingredients other than those described above. In the following, such ingredients are also referred to as “extra ingredients.”

Examples of extra ingredients include pH-adjusting agents, such as triethanolamine; chelating agents; preservatives/antimolds; antirusts; flame retardants; colorants excluding disperse dyes; surfactants excluding silicone surfactants; antioxidants; ultraviolet absorbers; oxygen absorbers; solubilizers; and penetrants.

Examples of chelating agents include salts of ethylenediaminetetraacetic acid. Examples of preservatives/antimolds include sodium benzoate, sodium pentachlorophenate, sodium 2-pyridinethiol-1-oxide, sodium sorbate, sodium dehydroacetate, 1,2-dibenzisothiazolin-3-one, and 4-chloro-3-methylphenol. Examples of antirusts include benzotriazole.

Compounds having the isothiazolinone-ring structure in the molecule, for example, are suitable for use as antimolds/preservatives.

Surfactants can be of various kinds, including anionic, cationic, and nonionic surfactants.

Preferably, the percentage of extra ingredients is 6.0% by mass or less, more preferably 5.0% by mass or less.

The lower limit on the percentage of extra ingredients is 0% by mass.

### 1-7. Other Details

According to this aspect of the present disclosure, the surface tension at 25° C. of the ink jet ink composition is not critical. Preferably, it is 20 mN/m or more and 50 mN/m or less, more preferably 21 mN/m or more and 40 mN/m or less, even more preferably 23 mN/m or more and 30 mN/m or less.

This prevents, for example, the clogging of the nozzles of the ink jet head used with the ink jet ink composition, further improving the stability of the ejection of the ink jet ink composition. Even if the nozzles become clogged, furthermore, they will recover better when capped.

The surface tension can be that measured by the Wilhelmy method. The surface tension can be measured using, for example, a surface tensiometer (e.g., Kyowa Interface Science CBVP-7).

According to this aspect of the present disclosure, it is preferred that the viscosity at 25° C. of the ink jet ink composition be 2 mPa·s or more and 10 mPa·s or less. More preferably, it is 3 mPa·s or more and 8 mPa·s or less, even more preferably, 4 mPa·s or more and 6 mPa·s or less.

This makes ink jet ejection of the ink jet ink composition more stable.

The viscosity can be determined by measuring it using a vibrational viscometer as per JIS Z 8809.

The ink jet ink composition according to this aspect of the present disclosure is for use by ink jet ejection. In the ejection process, the ink jet ink composition does not need to be ejected onto the final recording medium directly; it may be ejected onto an intermediate transfer medium first and then transferred to the final recording medium.

A particularly preferred use of the ink jet ink composition according to this aspect of the disclosure is textile printing by sublimation transfer, a printing process in which the ink composition is ejected onto an intermediate transfer medium first and then transferred by sublimation to fabric (recording medium).

In that case, the ink jet ink composition is applied to an intermediate medium having an ink-receiving coating, which means the fabric requires no pretreatment. By virtue of the colorant being the only component that sublimes and dyes the fabric, the color is vivid and fast, and the feel and texture is sturdy. The printer only needs to transport transfer paper; its simple mechanism unlike that of a fabric-transporting printer helps reduce cost. Involving no pretreatment, washing, and other complications, furthermore, the dyeing process requires no large steamer, hence low initial cost for investment in equipment, a small system footprint, and limited environmental burdens.

### 2. Ink Jet Ink Set

Another aspect of the present disclosure is an ink jet ink set.

The ink jet ink set according to this aspect of the present disclosure includes multiple ink jet ink compositions. At least one of the ink jet ink compositions is an ink jet ink composition according to the above aspect of the disclosure.

By virtue of this, the resulting ink jet ink set includes ink jet ink composition(s) highly stable when stored. The ink jet ink composition(s) allows for stable image formation and makes the ink jet ink set suitable to produce highly reliable recordings.

The ink jet ink set according to this aspect of the present disclosure includes multiple ink jet ink compositions, and the only requirement is that at least one of them be an ink jet ink composition according to the above aspect of the disclosure. Preferably, two or more ink jet ink compositions according to the above aspect of the disclosure are included.

This makes the above advantage more significant.

According to this aspect of the present disclosure, it is preferred that the ink jet ink compositions in the ink jet ink set include a light ink being an ink jet ink composition according to the above aspect of the disclosure; and a dark ink containing the same disperse dye as the light ink and a higher concentration of the disperse dye than the light ink.

For example, the ink jet ink set according to this aspect of the present disclosure may include ink jet ink compositions both containing a cyan disperse dye as the light and dark inks.

Alternatively, the ink jet ink set according to this aspect of the present disclosure may include ink jet ink compositions both containing a magenta disperse dye as the light and dark inks.

This is advantageous in that, for example, the image formed using the ink jet ink set will be better than in the related art in terms of color matching between the area of the light ink and that of the dark ink. The image will therefore be given, for example, a better look.

When the ink jet ink set according to this aspect of the present disclosure includes an ink containing a cyan disperse dye as the dark ink, it is preferred that the disperse dye content of the cyan ink as the dark ink be 3.5% by mass or more and 6.0% by mass or less. More preferably, the disperse dye content of the cyan ink is 4.0% by mass or more and 5.0% by mass or less.

This helps form an image with a sufficiently high color density. When the ink jet ink set according to this aspect of the present disclosure includes not only the cyan ink as the dark ink but also a light cyan ink as the light ink being an ink jet ink composition according to the above aspect of the disclosure, furthermore, the color matching between the area of the light ink and that of the dark ink will be better than in the related art. The image will therefore be given, for example, a better look.

Preferably, 0.18≤XLC/XDC≤0.70, where XDC is the disperse dye content (% by mass) of the cyan ink, which is the dark ink, and XLC is the disperse dye content (% by mass) of the light cyan ink, which is the light ink and contains the same disperse dye as the cyan ink. More preferably, 0.20≤XLC/XDC≤0.60, even more preferably 0.30≤XLC/XDC≤0.40.

This helps form an image with a sufficiently high color density. The color matching between the area of the light ink and that of the dark ink, furthermore, will be even better, and the image will be given, for example, an even better look.

When the ink jet ink set according to this aspect of the present disclosure includes a magenta ink as the dark ink, it is preferred that the disperse dye content of the magenta ink as the dark ink be 5.0% by mass or more and 8.0% by mass or less. More preferably, the disperse dye content of the dark magenta ink is 6.0% by mass or more and 7.0% by mass or less.

This helps form an image with a sufficiently high color density. When the ink jet ink set includes not only the magenta ink as the dark ink but also a light magenta ink as the light ink being an ink jet ink composition according to the above aspect of the disclosure, furthermore, the color matching between the area of the light ink and that of the dark ink will be better than in the related art. The image will therefore be given, for example, a better look.

Preferably, 0.18≤XLM/XDM≤0.70, where XDM is the disperse dye content (% by mass) of the magenta ink, which is the dark ink, and XLM is the disperse dye content (% by mass) of the light magenta ink, which is the light ink and contains the same disperse dye as the magenta ink. More preferably, 0.20≤XLM/XDM≤0.60, even more preferably 0.25≤XLM/XDM≤0.30.

This helps form an image with a sufficiently high color density. The color matching between the area of the light ink and that of the dark ink, furthermore, will be even better, and the image will be given, for example, an even better look.

A dark ink as described above can be one that contains, for example, the ingredients described as those of an ink jet ink composition according to an aspect of the present disclosure.

### 3. Recording Method

Another aspect of the present disclosure is a recording method performed using at least one ink jet ink composition according to an aspect of the disclosure.

Ink jet ink compositions and ink jet ink sets according to the above aspects of the disclosure can be applied to, for example, direct printing and thermal transfer printing. An example of the latter is textile printing by sublimation transfer.

The following describes an exemplary process of thermal transfer printing as a recording method performed using an ink jet ink composition according to an aspect of the present disclosure.

A recording method according to an embodiment includes an ink attachment step, in which the ink jet ink composition is attached to an intermediate transfer medium by ink jet technology; and a transfer step, in which the disperse dye contained in the ink jet ink composition is transferred to a recording medium.

### 3-1. Ink Attachment Step

In the ink attachment step, the ink jet ink composition is attached to an intermediate transfer medium by ink jet technology. The ink jet ejection of the ink jet ink composition can be achieved using a known ink jet recording apparatus. Examples of ejection techniques that can be used include piezoelectric ejection and ejection using bubbles produced by heating the ink. Piezoelectric ejection is particularly preferred, for example because of low risk of denaturing the ink jet ink composition.

It should be noted that the ink attachment step may involve inks that are not ink jet ink compositions according to an aspect of the present disclosure. For example, the ink attachment step may be performed using an ink jet ink set that includes ink jet ink composition(s) according to an aspect of the present disclosure and other ink jet ink composition(s).

### 3-2. Intermediate Transfer Medium

Examples of intermediate transfer media that can be used include paper, such as ordinary printing paper, and a recording medium having an ink-receiving layer, called ink jet paper or coated paper. Paper having an ink-receiving layer formed by silica or other inorganic fine particles is particularly preferred. Such a type of paper, when used as the intermediate recording medium, allows the attached ink jet ink composition thereon to dry with limited degrees of bleeding and other defects. The disperse dye thereon, furthermore, tends to sublimate more smoothly in the subsequent, transfer step.

### 3-3. Transfer Step

Then the intermediate transfer medium with the attached ink jet ink composition thereon is heated to transfer the disperse dye as a component of the ink jet ink composition to a recording medium. This gives a recording.

Preferably, the heating temperature in this step is 160° C. or above and 230° C. or below, although it depends partly on factors such as the disperse dye used. More preferably, the heating temperature is 170° C. or above and 230° C. or below.

This ensures the transfer can be achieved with less energy, helping improve throughput. The color strength, for example, of the resulting recording will also be improved.

Preferably, the duration of heating in this step is 30 seconds or more and 90 seconds or less, although it depends partly on the heating temperature. More preferably, the duration of heating is 45 seconds or more and 80 seconds or less.

This ensures the transfer can be achieved with less energy, helping improve throughput. The color strength, for example, of the resulting recording will also be improved.

While the intermediate transfer medium with the attached ink jet ink composition thereon is being heated in this step, the inked side may be facing the recording medium with a certain distance therebetween or may be in contact with the surface of the recording medium. Preferably, the intermediate transfer medium is heated with its inked side in contact with the surface of the recording medium.

This ensures the transfer can be achieved with less energy, helping improve throughput. The color strength, for example, of the resulting recording will also be improved.

### 3-4. Recording Medium

The recording medium can be of any kind. Examples include fabric, such as hydrophobic fiber fabric, resin film, paper, glass, metal, and ceramics. The recording medium may be shaped like a sheet or may even have some height like a ball or cuboid block.

When the recording medium is fabric, examples of textile fibers that can be used include polyester fiber, nylon fiber, triacetate fiber, diacetate fiber, polyamide fiber, cellulose fiber, and blends of two or more of these fibers. Blends of these fibers with a regenerated fiber, such as rayon, or with a natural fiber, such as cotton, silk, or wool, may also be used.

The fabric, furthermore, can be in various weaves. Examples include the plain, twill, and satin weaves, variations of the plain, twill, and satin weaves, fancy or figured weaves, the warp or weft backed, double, and multiple weaves, the warp and weft pile weaves, and the leno or gauze weave.

The thickness of the fibers forming the fabric can be, for example, 10 d or more and 100 d or less.

When the recording medium is resin film, examples of resin films that can be used include polyester film, polyurethane film, polycarbonate film, polyphenylene sulfide film, polyimide film, and polyamide-imide film.

The resin film may be a stack of multiple layers (multilayer film) or may be one made from a compositionally graded material.

### 4. Ink Jet Recording Apparatus

Another aspect of the present disclosure is an ink jet recording apparatus.

The ink jet recording apparatus according to this aspect of the present disclosure includes at least one ink jet ink composition according to an aspect of the disclosure.

By virtue of this, the ink jet recording apparatus allows for stable image formation and is suitable to produce highly reliable recordings.

The following describes the ink jet recording apparatus according to this aspect of the disclosure in its preferred embodiment with reference to drawings. The following embodiment represents a certain form of this aspect of the disclosure, and any change can be made to it within the scope of the technical idea of the aspect. In the drawings, the layers and elements are not to scale so that the reader can recognize each layer or element.

The advantages of this aspect of the present disclosure, described above, become significant particularly when the ink jet recording apparatus has, like that described below, high-capacity tanks for ink jet ink compositions and has more than one ink tank for each single type of ink jet ink composition that can be switched between, for example according to the usage of the ink jet ink compositions.

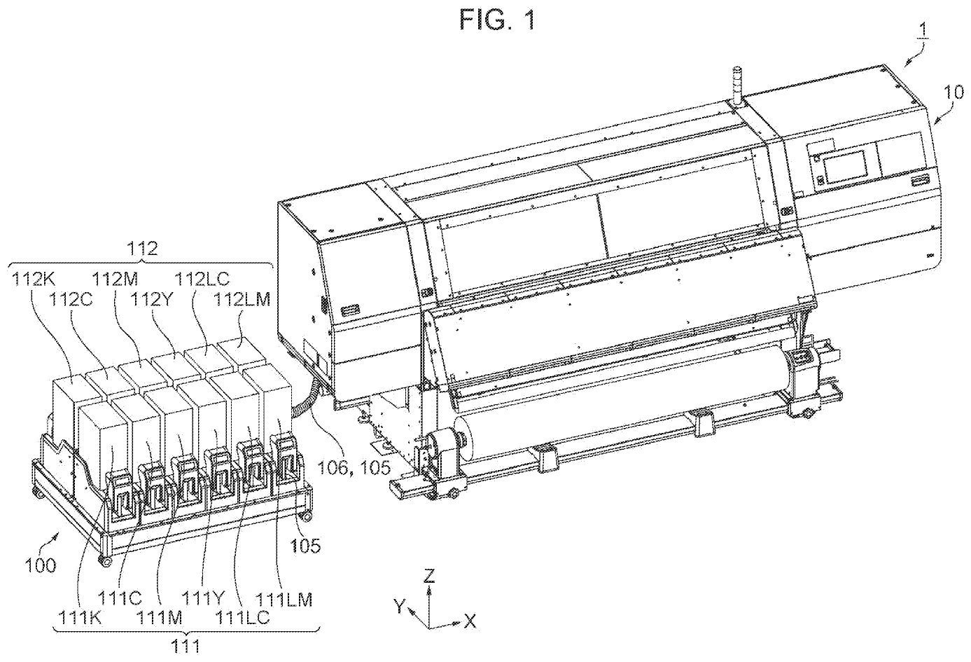

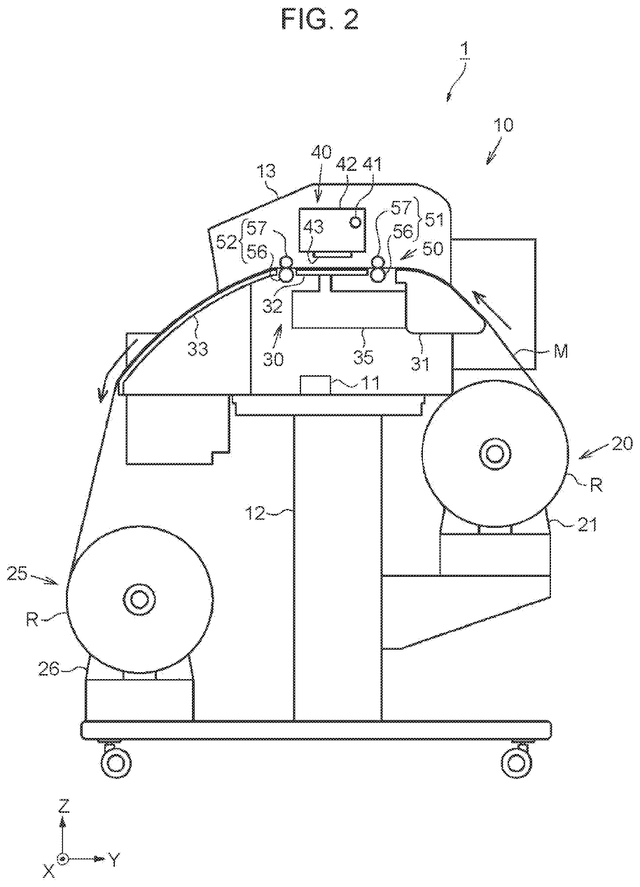

FIG. 1 is a perspective view of the ink jet recording apparatus according to this embodiment, illustrating an overview of the apparatus. FIG. 2 is a cross-sectional view of a droplet ejector as a component of the ink jet recording apparatus according to this embodiment, illustrating an overview of the ejector.

First, the ink jet recording apparatus 1 according to this embodiment and its droplet ejector 10 are outlined with reference to FIGS. 1 and 2. The ink jet ink composition dispenser 100, another component of the ink jet recording apparatus 1 according to this embodiment, will be detailed later.

As illustrated in FIG. 1, the ink jet recording apparatus 1 according to this embodiment includes a droplet ejector 10 and an ink jet ink composition dispenser 100. The ink jet ink composition dispenser 100 supplies ink jet ink compositions to the droplet ejector 10. The droplet ejector 10 has an ejection unit, which ejects the ink jet ink compositions supplied from the ink jet ink composition dispenser 100 onto a medium M. In this embodiment, the droplet ejector 10 is a large-format printer; it transports the medium M roll-to-roll and prints an image on a large-sized medium M, such as A0 or B1.

In the following description, the direction of the width, or the longitudinal axis, of the droplet ejector 10 is defined as the X direction. The direction of the depth, or the transverse axis, of the droplet ejector 10 is the Y direction, and the direction of the height of the droplet ejector 10 is the Z direction. The arrows indicating the directions have their point on the + side and their base on the − side.

As illustrated in FIG. 2, the droplet ejector 10 has a body 13 supported by a stand 12.

Inside the body 13 of the droplet ejector 10 is a controller 11. Having components such as a CPU and a memory, the controller 11 controls each section of the droplet ejector 10. The controller 11 also controls the supply of ink jet ink compositions from the ink jet ink composition feeder 100.

The droplet ejector 10 also includes a feeder 20, which feeds the medium M from the outside to the inside of the body 13; and a support 30, which supports the medium M fed by the feeder 20. Other sections of the droplet ejector 10 include a transport 50, which transports the medium M on the support 30; a printing unit 40, which prints the image on the medium M supported by the support 30; and a reel 25, around which the medium M with the image thereon printed by the printing unit 40 and discharged out of the body 13 is wound.

In this embodiment, the droplet ejector 10 has the feeder 20 and reel 25 outside the body 13 and the support 30, transport 50, and printing unit 40 inside the body 13.

The feeder 20 is on the rear side of the droplet ejector 10, or on the +Y side in FIG. 2, and has a holder 21 that holds a cylindrical roll R of the medium M. The holder 21 is fitted on the stand 12 and rotatably holds the roll R. The feeder 20 turns the roll R in one direction, counterclockwise in FIG. 2, thereby feeding the medium M out of the roll R into the body 13.

The support 30 supports the medium M from below, or from the −Z side in FIG. 2, and includes first, second, and third support sections 31, 32, and 33. The first, second, and third support sections 31, 32, and 33 are in a row, with the first support section 31 on the rear side of the droplet ejector 10 and the third support section 33 on the opposite, front side, or the −Y side in FIG. 2. Part of the first and third support sections 31 and 33 is outside the body 13, exposed. The first support section 31 guides the medium M fed from the feeder 20 to the second support section 32, the second support section 32 guides the medium M guided from the first support section 31 to the third support section 33, and the third support section 33 guides the medium M guided from the second section 32 to the reel 25.

That is, the first, second, and third support sections 31, 32, and 33 form a route of transport of the medium M extending from the rear side to the front side of the droplet ejector 10. The first and second support sections 31 and 32 are fitted on a base 35 installed in the body 13.

The printing unit 40 includes a guide shaft 41, extending in the X direction; a carriage 42, supported by the guide shaft 41; and multiple ejection heads 43, which eject the ink jet ink compositions onto the medium M. The carriage 42 shuttles back and forth in the X direction, sliding on the guide shaft 41. The ejection heads 43 are in a row in the X direction. Each of the ejection heads 43 ejects one of six ink jet ink compositions, namely light cyan ink (light ink), light magenta ink (light ink), cyan ink (dark ink), magenta ink (dark ink), yellow ink, and black ink. The ejection heads 43 are held by the carriage 42 to face the medium M supported by the second support section 32. As a result of the carriage 42 moving along the guide shaft 41 and ejecting ink jet ink compositions in different colors from the multiple ejection heads 43, the printing unit 40 prints a full-color image on the medium M. Each of the ejection heads 43 has a nozzle plate (not illustrated), a plate having multiple nozzles through which an ink jet ink composition is ejected.

The ejection heads 43 are an example of an ejection unit.

The reel 25 is on the front side of the droplet ejector 10 and has a holder 26 that holds a cylindrical roll R of the medium M. The holder 26 is fitted on the stand 12 and rotatably holds the roll R. As a result of the reel 25 turning the roll R in one direction, counterclockwise in FIG. 2, the medium M with the image thereon printed by the printing unit 40 is wound around the reel 25.

The transport 50 includes a pair of transport rollers 51, which is between the first and second support sections 31 and 32 in the route of transport formed by the support 30; and another pair of transport rollers 52, which is between the second and third support sections 32 and 33.

It should be noted that this embodiment describes a droplet ejector 10 having two pairs of rollers 51 and 52 by way of example, but in other possible configurations, the droplet ejector 10 may have a single pair of transport rollers or may have three or more pairs of transport rollers.

Each pair of transport rollers 51 or 52 has a driving roller 56, touching the medium M from below, and a driven roller 57, touching the medium M from above, or from the +Z side in FIG. 2.

At the pairs of transport rollers 51 and 52, a motor (not illustrated) as the power source for the driving rollers 56 runs to turn the driving roller 56. The driven rollers 57 rotate as the driving rollers 56 rotate. The pairs of transport rollers 51 and 52 transport the medium M along the route of transport, with the medium M sandwiched between the driving and driven rollers 56 and 57.

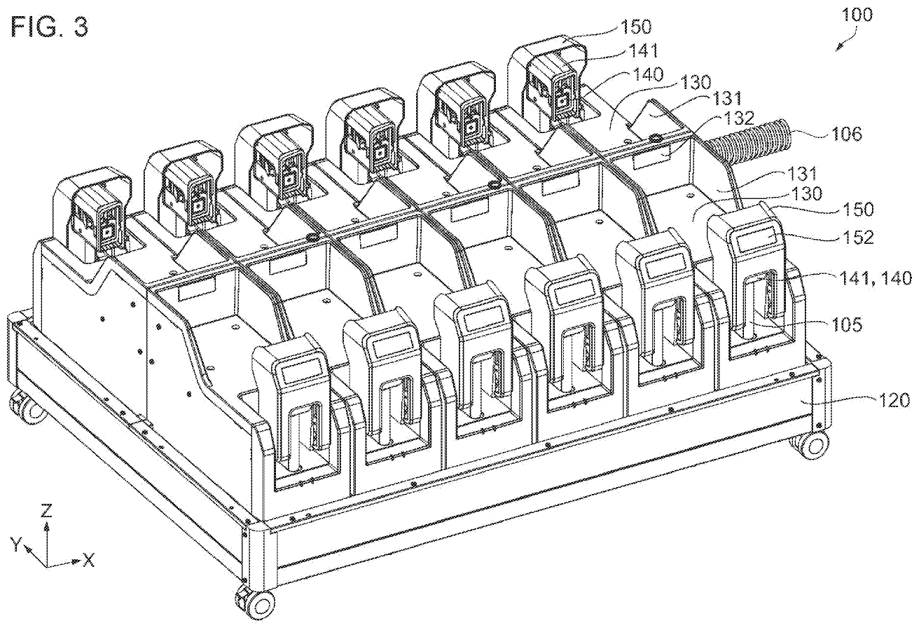

FIGS. 3 to 7 are perspective views of the ink jet ink composition dispenser according to this embodiment, each illustrating an overview of the dispenser.

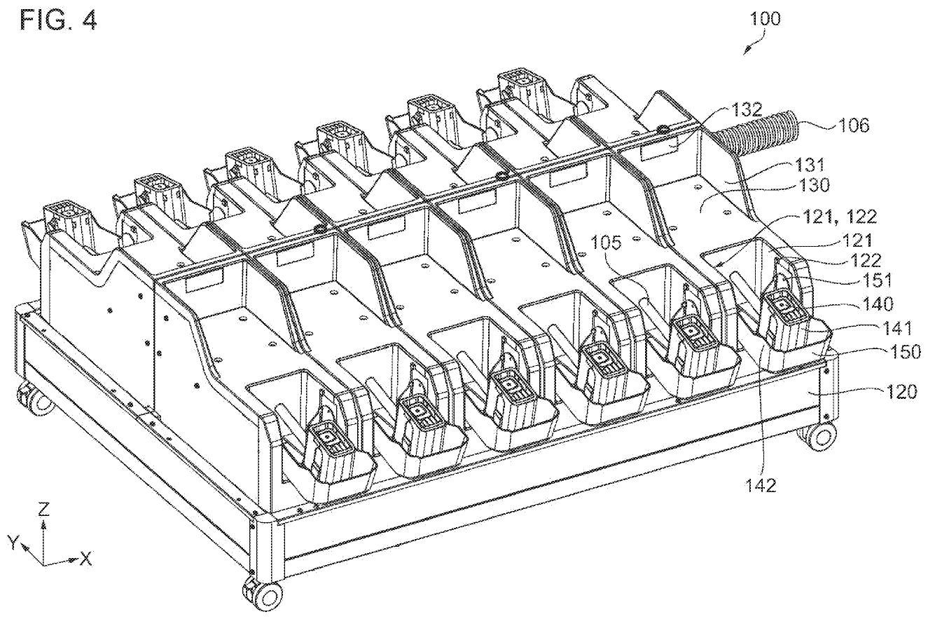

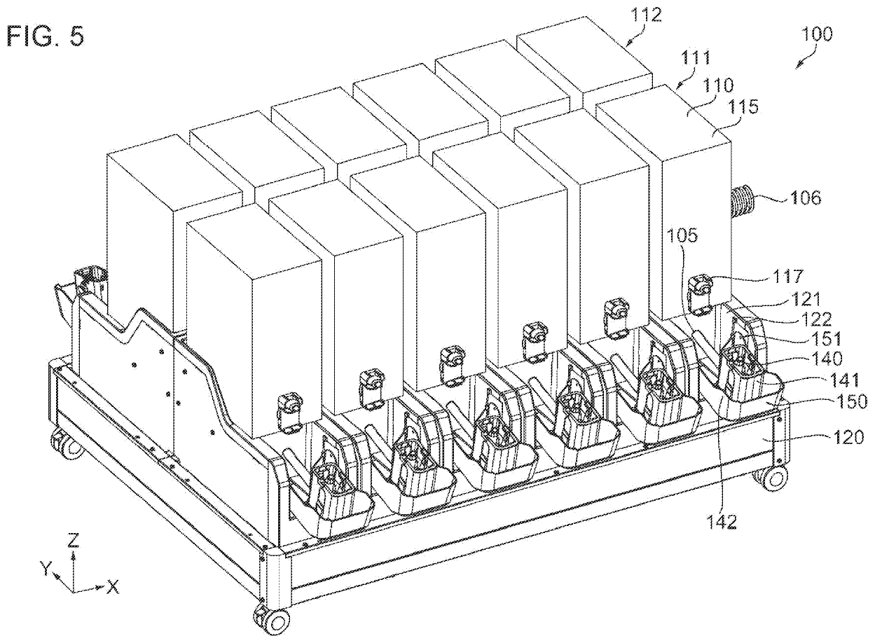

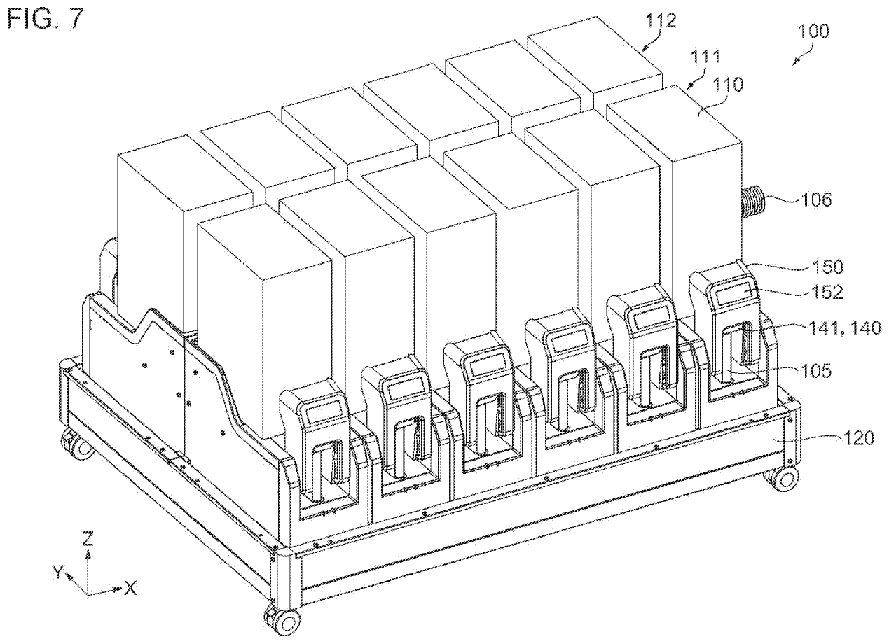

In FIGS. 3 and 4, the ink jet ink composition dispenser 100 has no tanks 110 thereon. In FIGS. 5 to 7, the ink jet ink composition dispenser 100 has tanks 110 thereon. In FIGS. 3 and 7, furthermore, covers 150 are in the position where they protect couplers 140. In FIGS. 4 to 6, covers 150 are in the position where they leave couplers 140 exposed.

In the following description, when a cover 150 is in the position where it protects a coupler 140, the cover 150 is “closed.” When a cover 150 is in the position where it leaves a coupler 140 exposed, the cover 150 is “open.”

The following outlines the ink jet ink composition dispenser 100 according to this embodiment with reference to FIGS. 1 and 3 to 7.

As illustrated in FIG. 1, the droplet ejector 10 of the ink jet recording apparatus 1 is coupled to the ink jet ink composition dispenser 100 by multiple tubes 105. The tubes 105 are laid in a thick protecting duct 106 and are protected by the protecting duct 106. The number of tubes 105 is not critical. In the illustrated configuration, the ink jet recording apparatus 1 has twelve tubes 105.

The tubes 105 and the protecting duct 106 are flexible and can be bent. By virtue of this, the droplet ejector 10 and the ink jet ink composition dispenser 100 can move within the reach of the tubes 105 and the protecting duct 106.

In this embodiment, it is assumed that the longitudinal axis of the ink jet ink composition dispenser 100 is parallel with the X direction. The transverse axis of the ink jet ink composition dispenser 100 is parallel with the Y direction, and the height of the ink jet ink composition dispenser 100 is parallel with the Z direction.

The ink jet ink composition dispenser 100 according to this embodiment has first tanks 111 and second tanks 112 thereon. Each of the multiple first tanks 111 contains one of the six ink jet ink compositions, and so does each of the multiple second tanks 112. That is, the ink jet ink composition dispenser 100 according to this embodiment can accommodate at least one first tank 111 and at least one second tank 112 thereon.

The at least one first tank 111 includes a tank 111LM containing light magenta ink, a tank 111LC containing light cyan ink, a tank 111Y containing yellow ink, a tank 111M containing magenta ink, a tank 111C containing cyan ink, and a tank 111K containing black ink.

While on the ink jet ink composition dispenser 100, the first tanks 111 are in the following order in the X direction: the tank 111LM containing light magenta ink, the tank 111LC containing light cyan ink, the tank 111Y containing yellow ink, the tank 111M containing magenta ink, the tank 111C containing cyan ink, and the tank 111K containing black ink.

The at least one second tank 112 includes a tank 112LM containing light magenta ink, a tank 112LC containing light cyan ink, a tank 112Y containing yellow ink, a tank 112M containing magenta ink, a tank 112C containing cyan ink, and a tank 112K containing black ink.

While on the ink jet ink composition dispenser 100, the second tanks 112 are in the following order in the X direction: the tank 112LM containing light magenta ink, the tank 112LC containing light cyan ink, the tank 112Y containing yellow ink, the tank 112M containing magenta ink, the tank 112C containing cyan ink, and the tank 112K containing black ink.

The capacity of each tank, or that of the tanks 111LM, 111LC, 111Y, 111M, 111C, and 111K and of the tanks 112LM, 112LC, 112Y, 112M, 112C, and 112K, is not critical. Preferably, all tanks have a capacity of 1 L or more. It is more preferred that all tanks have a capacity of 1 L or more and 20 L or less, even more preferably 3 L or more and 20 L or less.

Using such high-capacity tanks makes the advantages of this aspect of the present disclosure, described above, more significant.

Inside the ink jet recording apparatus 1, either the ink jet ink compositions contained separately in the six tanks 111LM, 111LC, 111Y, 111M, 111C, and 111K or those in the six tanks 112LM, 112LC, 112Y, 112M, 112C, 112K are supplied to the ejection heads 43 of the droplet ejector 10 through the tubes 105.

In the following description, the tanks 111LM, 111LC, 111Y, 111M, 111C, and 111K and the tanks 112LM, 112LC, 112Y, 112M, 112C, 112K may be referred to as the tanks 110.

The portion of the ink jet ink composition dispenser 100 where it has the first tanks 111 on and the portion where it has the second tanks 112 on are symmetric with respect to the XZ plane and have the same structure. The following description, therefore, focuses on the portion of the ink jet ink composition dispenser 100 where it has the first tanks 111 on; the portion where it has the second tanks 112 on is not described.

As illustrated in FIGS. 3 to 7, the ink jet ink composition dispenser 100 has a base 120; mounts 130, on which tanks 110 containing ink jet ink compositions can be placed; tubes 105, through which the ink jet ink compositions in the tanks 110 can be supplied to the droplet ejector 10; couplers 140, coupled to the tubes 105 and attachable to and detachable from the tanks 110; and covers 150, which protect the couplers 140. As illustrated in FIG. 4, furthermore, the ink jet ink composition dispenser 100 also has detectors 151, which detect the position of the covers 150.

As illustrated in FIG. 5, the tanks 110 have a casing 115, made from cardboard; a container (not illustrated) for the ink jet ink composition, which is inside the casing 115; and a coupling port 117, coupled to the container for the ink jet ink composition and sticking out of the casing 115. The container for the ink jet ink composition is made of, for example, a polyethylene resin so that it will not be corroded by the ink jet ink composition.

The tanks 110 are also equipped with a semiconductor board (not illustrated), which stores information about the ink jet ink composition contained in the container.

Referring back to FIGS. 3 to 7, the mounts 130 are supported by a base 120 placed lower in the direction of height, or on the −Z side. The positions of the mounts 130 and the couplers 140 on the ink jet ink composition dispenser 100 have been adjusted so that when tanks 110 are placed on the mounts 130, the coupling port 117 of the tanks 110 will be coupled to the corresponding coupler 140.

Around the mounts 130 extends walls 131 upward in the direction of height, or in the +Z direction. The walls 131 limit the movement of a tank 110 placed on the mount 130 by coming into contact with the tank 110. That is, the walls 131 around each mount 130 are an example of a second limiter.

By virtue of the walls 131, a tank 110 placed on the mount 130 does not move easily but is stable on the mount 130.

The walls 131 have an attached label 132, which tells the user what type of ink jet ink composition is in the tank 110 placed on the mount 130. Likewise, the cover 150 has an attached label 152 that tells the user what type of ink jet ink composition is in the tank 110 placed on the mount 130.

To be more exact, the compartment for a tank 110 containing light magenta ink has labels in light magenta 132 and 152 thereon. That for a tank 110 containing light cyan ink has labels in light cyan 132 and 152 thereon, and that for a tank 110 containing yellow tank has labels in yellow 132 and 152 thereon. The compartment for a tank 110 containing magenta ink is labeled with labels in magenta 132 and 152, and that for a tank 110 containing cyan ink is labeled with labels in cyan 132 and 152. The compartment where a tank 110 containing black ink is placed has labels in black 132 and 152 thereon. From the color of the labels 132 and 152, the user can know what type of ink jet ink composition is in the tank 110 on the mount 130.

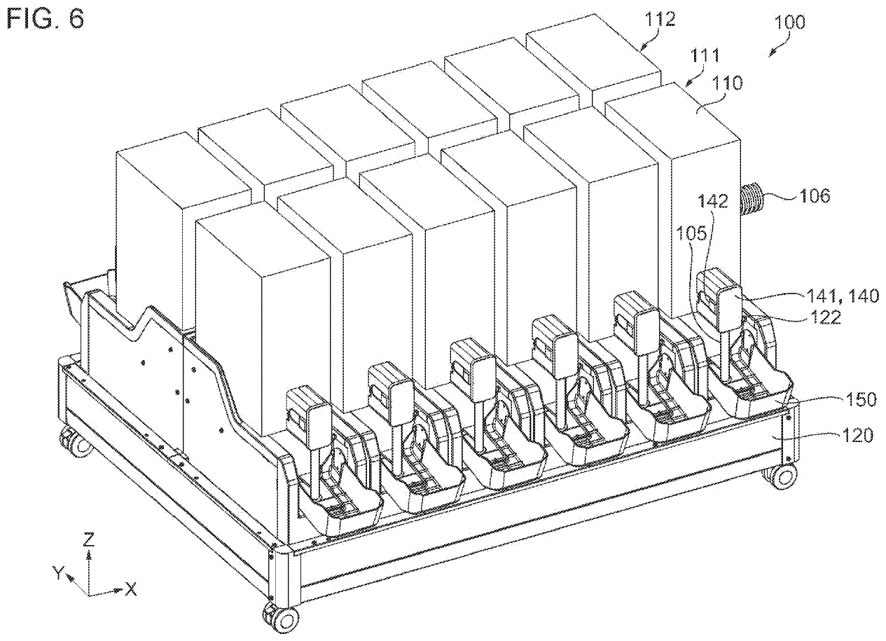

Around each cover 150 on the base 120, walls 121 extend upward in the direction of height, or in the +Z direction. The cover 150 is inside the walls 121 and held by the walls 121 in such a manner it can swing in the Z direction. While a coupler 140 is coupled to the coupling port 117 of a tank 110, the cover 150 is set to the position where it covers the handle 141 of the coupler 140, illustrated in FIG. 7, or the position where it leaves the handle 141 of the coupler 140 exposed, illustrated in FIG. 6.

As stated, when a cover 150 is in the position where it covers the handle 141 of a coupler 140 as in FIG. 7, the cover 150 is “closed.” This “handle covered” position of a cover 150 is hereinafter referred to as the first position. When a cover 150 is in the position where it does not cover the handle 141 of a coupler 140 as in FIG. 6, the cover 150 is “open.” This “handle uncovered” position of a cover 150 is hereinafter referred to as the second position.

This allows the cover 150 to move between the first position, where it covers the handle 141 of the corresponding coupler 140, and the second position, where it does not, while the coupler 140 is attached to a tank 110 placed on the mount 130. The cover 150 moves between the first and second positions by swinging in relation to the mount 130 around an axis parallel with the X direction.

The couplers 140 are liquid couplers configured to be coupled to the coupling port 117 of tanks 110. One end of a coupler 140 is coupled to the coupling port 117 of a tank 110, and the other end is coupled to a tube 105. As a result, while the coupler 140 is coupled to the coupling port 117 of a tank 110, the ink jet ink composition in the tank 110 is supplied to the droplet ejector 10 through the coupler 140 and the tube 105.

The coupler 140 has a handle 141, which is also the casing of the coupler 140. The user swings the coupler 140 in the Z direction by holding this handle 141. The coupler 140 is also equipped with a lever 142, which is used to lock and release the coupling between the coupler 140 and the coupling port 117 of a tank 110.

The coupler 140, furthermore, has a coupling element (not illustrated) that allows the coupler 140 to be electrically coupled to the semiconductor board of a tank 110. While the coupler 140 is coupled to the coupling port 117 of a tank 110, the semiconductor board of the tank 110 is electrically coupled to the controller 11 by this coupling element, allowing the controller 11 to access information about the ink jet ink composition contained in the tank 110.

The shape of the cover 150 is not critical as long as it can protect the joint between the coupling port 117 of a tank 110 and the coupler 140. For example, the cover 150 may be hemispherical or may be hemicylindrical.

The cover 150, furthermore, may be made to protect only the lever 142. That is, the structure of the cover 150 only needs to provide either the protection of the joint between the coupling port 117 of a tank 110 and the coupler 140 or the protection of the lever 142, or both.

While a coupler 140 is coupled to the coupling port 117 of a tank 110, the corresponding walls 121 on the base 120 are in the position where they sandwich the handle 141 of the coupler 140, or the joint between the coupling port 117 of the tank 110 and the coupler 140. In other words, the base 120 has pairs of walls 121 thereon each of which sandwich the handle 141 of a coupler 140 while the coupler 140 is coupled to the coupling port 117 of a tank 110.

Each of the paired walls 121 has, as illustrated in FIG. 4, a projection 122 sticking into the space between the pair of walls 121. The projections 122 are configured to come into contact with the cover 150. When the user flips the cover 150 to the first position, where the cover 150 covers the handle 141 of the coupler 140, the projections 122 limit the movement of the cover 150 to prevent it from touching the coupler 140. That is, the walls 121 have projections 122 configured to come into contact with the cover 150 and limit the contact of the cover 150 with the coupler 140 coupled to a tank 110 while the cover 150 is in the first position, where it covers the handle 141 of the coupler 140.

The projections 122 are an example of a limiter.

The detectors 151, which are so-called torque switches, are on the walls 121 on the base 120 and detect the position of the covers 150. Each detector 151 is configured such that an actuator of the torque switch is pressed when the cover 150 is closed, and the actuator is released when the cover 150 is open. The controller 11 detects whether the covers 150 are open or closed based on signals sent from the detectors 151.

When the ink jet ink composition dispenser 100 according to this embodiment is running out of the ink jet ink composition in a tank 110, the user removes the coupler 140 from the nearly empty tank 110 and then dismounts the tank 110 from the mount 130. Then the user places a new tank 110 on the mount 130 and couples the coupler 140 to this tank 110.

The following describes how the user can replace a tank 110 running out of the ink jet ink composition therein with a new tank 110.

When a tank 110 is running out of the ink jet ink composition therein, the user flips the cover 150 and brings it to the second position, where it does not cover the handle 141 of the coupler 140, as illustrated in FIG. 6. Then, as in FIG. 5, the user moves the lever 142 to the position where it releases the coupling between the coupler 140 and the coupling port 117 of the tank 110, and removes the coupler 140 from the coupling port 117 of the tank 110. Then, as in FIG. 4, the user dismounts the nearly empty tank 110 from the mount 130.

In this embodiment, each cover 150 is configured to support, in its second position, the coupler 140 after removal from a tank 110 placed on the mount 130. In other words, when a coupler 140 is removed from the coupling port 117 of a tank 110 while the cover 150 is in the second position, where it does not cover the handle 141 of the coupler 140, the cover 150 supports the coupler 140 removed from the tank 110 to prevent it from falling in the −Z direction.

If there were no cover 150, the coupler 140 removed from the tank 110 would fall in the −Z direction. The fall could apply extra force to the joint between the coupler 140 and the tube 105, causing the coupler 140 to dislodge itself from the tube 105. Accidental dislodgement of the coupler 140 from the tube 105, furthermore, could cause air to enter the corresponding ejection head 43 of the droplet ejector 10. When the ejection heads 43 of the droplet ejector 10 eject ink jet ink compositions, the ejection head 43 with entrained air therein would eject the air through its nozzles instead of the ink jet ink composition it should. This would cause voids to be present in place of dots formed by the ink jet ink compositions, namely ink dots. Voids in ink dots can affect the quality of the resulting image.

In this embodiment, any coupler 140 removed from a tank 110 is supported by the corresponding cover 150 and does not fall in the −Z direction. The joints between the couplers 140 and the tubes 105, therefore, are not easily subjected to extra force, helping prevent the problem of, for example, reduced image quality caused by the dislodgement of a coupler 140 from a tube 105 and the subsequent entry of air into an ejection head 43 of the droplet ejector 10.

Then, as illustrated in FIG. 5, the user places a new tank 110 on the mount 130. The user then couples the coupler 140 to the coupling port 117 of the tank 110 as in FIG. 6. Subsequently, the user moves the lever 142 to the position where it locks the coupling between the coupler 140 and the coupling port 117 of the tank 110.

Then, as illustrated in FIG. 7, the user flips the cover 150 and brings it to the first position, where it covers the handle 141 of the coupler 140. As a result, either the coupler 140 or the joint between the coupler 140 and the coupling port 117 of the tank 110, or both, are protected by the cover 150.

When the user flips the cover 150, the projections 122 on the walls 121 limit the movement of the cover 150 to prevent it from touching the handle 141 of the coupler 140. By virtue of this, the user can flip the cover 150 to the first position, where it covers the handle 141 of the coupler 140, without causing extra force to the joint between the coupler 140 and the coupling port 117 of the tank 110. The joint between the coupler 140 and the coupling port 117 of the tank 110, furthermore, is locked by the lever 142 and protected by the cover 150. Accidental dislodgement of the coupler 140 from the coupling port 117 of the tank 110, therefore, is rare, helping ensure stable supply of the ink jet ink composition in the tank 110 to the droplet ejector 10.

Besides the first tanks 111, containing six ink jet ink compositions, the ink jet ink composition dispenser 100 according to this embodiment also have second tanks 112 on, also containing six ink jet ink compositions. The user can switch the source of ink jet ink composition supply to the droplet ejector 10 between a first tank 111 and a second tank 112.

For example, when the tank 111LM (an example of a first tank 111) is running out of light magenta ink after supplying it to the droplet ejector 10, the user can switch the source of light magenta ink supply so that the tank 112LM (an example of a second tank 112) will supply light magenta ink.

To take another example, when the tank 112LM (an example of a second tank 112) is running out of light magenta ink after supplying it to the droplet ejector 10, the user can switch the source of light magenta ink supply so that the tank 111LM (an example of a first tank 111) will supply light magenta ink.

The same applies to the light cyan, yellow, magenta, cyan, and black inks; the user can switch the source of the ink jet ink composition supply to the droplet ejector 10 between a first tank 111 and a second tank 112.

The switching of the source of ink jet ink composition supply to the droplet ejector 10 is done either manually by the user or automatically. The following describes automatic switching of the source of ink jet ink composition supply to the droplet ejector 10.

In this embodiment, the controller 11 of the ink jet recording apparatus 1 automatically stops the ink jet ink composition supply from a first tank 111 to the droplet ejector 10 when it detects a movement of the cover 150 for the tank 110 to the second position, where the cover 150 does not cover the handle 141 of the coupler 140, based on a signal from the corresponding detector 151. Then the controller 11 automatically switches the source of the ink jet ink composition supply to the droplet ejector 10 from the first tank 111 to the corresponding second tank 112.

For example, the tank 111LM (an example of a first tank 111) may be running out of light magenta ink after supplying it to the droplet ejector 10, and the user may bring the cover 150 for the coupler 140 coupled to the tank 111LM to the second position to remove the coupler 140 from the tank 111LM. In that case, the controller 11 detects the movement of the cover 150 to the second position, where the cover 150 does not cover the handle 141 of the coupler 140, based on a signal from the corresponding detector 151 and automatically stops the light magenta ink supply from the tank 111LM. Then the controller 11 automatically switches the source of the ink jet ink composition supply to the droplet ejector 10 from the tank 111LM (an example of a first tank 111) to the tank 112LM (an example of a second tank 112).

The same applies to the light cyan, yellow, magenta, cyan, and black inks; when the user wants to remove a coupler 140 from a tank 110 that is an example of a first tank 111 and hence brings the cover 150 to the second position, the controller 11 automatically stops the ink jet ink composition supply from this tank 110 being an example of a first tank 111 and switches the source of the ink jet ink composition supply to the droplet ejector 10 from this tank 110 as an example of a first tank 111 to a tank 110 that is an example of a second tank 112.

Likewise, the user may want to remove a coupler 140 from a tank 110 for light magenta, light cyan, yellow, magenta, cyan, or black ink that is an example of a second tank 112 and hence bring the cover 150 for the coupler 140, which is coupled to the tank 112LM, 112LC, 112Y, 112M, 112C, or 112K, to the second position. In that case, the controller 11 automatically stops the ink jet ink composition supply from this tank 110 being an example of a second tank 112 and switches the source of the ink jet ink composition supply to the droplet ejector 10 from this tank 110 as an example of a second tank 112 to the corresponding tank 110 that is an example of a first tank 111.

It is to be understood that the foregoing is a description of preferred embodiments of aspects of the present disclosure, and no aspect of the present disclosure is limited to them.

For example, the ink jet recording apparatus according to an aspect of the present disclosure does not need to have the structure described above. Its structure is not critical as long as at least one ink jet ink composition according to an aspect of the present disclosure is included.

### EXAMPLES

The following describes specific examples of an aspect of the present disclosure.

### 5. Preparation of light Inks as Ink Jet Ink Compositions

### Example LM1

A light magenta ink (light ink) was prepared as an ink jet ink composition having the formula given in Table 1. First, a mixture of 15 parts by mass of C.I. Disperse Red 60 (disperse dye), 15 parts by mass of a sulfonated naphthalene-formaldehyde condensate (dispersant), and 70 parts by mass of deionized water was stirred until it became a slurry.

This slurry was put into a mixing tank of a bead mill, and the dye was dispersed with 0.3-mm zirconia beads to a specific surface area of the disperse dye of 3.0 m²/g. The amount of the beads was 80% by volume of the milling chamber.

To the resulting liquid dispersion of disperse dye were added SILFACE SAG503A (Nissin Chemical Industry), a silicone surfactant having a chemical structure represented by the formula above, glycerol, propylene glycol, triethylene glycol monomethyl ether, triethanolamine, Proxel XL-2(S) (Lonza), and deionized water in the specified proportions, and the ingredients were mixed and stirred for 2 hours with a magnetic stirrer. The stirred mixture was filtered through a 1-μm membrane filter.

### Examples LM2 to LM6

Ink jet ink compositions were prepared as in Example LM1, except that the percentages of the ingredients were changed according to the formula presented in Table 1.

### Comparative Examples LM1 and LM2

Ink jet ink compositions were prepared as in Example LM1, except that the percentages of the ingredients were changed according to the formula presented in Table 1.

### Comparative Examples LM3 and LM4

Ink jet ink compositions were prepared as in Example LM1, except that the SILFACE SAG503A (Nissin Chemical Industry) silicone surfactant was replaced with BYK-348 (BYK Chemie), and the percentages of the ingredients were changed according to the formula presented in Table 1.

### Example LC1

A light cyan ink (light ink) was prepared as an ink jet ink composition having the formula given in Table 1. First, a mixture of 15 parts by mass of C.I. Disperse Blue 359 (disperse dye), 15 parts by mass of a sulfonated naphthalene-formaldehyde condensate (dispersant), and 70 parts by mass of deionized water was stirred until it became a slurry.

This slurry was put into a mixing tank of a bead mill, and the dye was dispersed with 0.3-mm zirconia beads to a specific surface area of the disperse dye of 3.0 m²/g. The amount of the beads was 80% by volume of the milling chamber.

To the resulting liquid dispersion of disperse dye were added SILFACE SAG503A (Nissin Chemical Industry), a silicone surfactant having a chemical structure represented by the formula above, glycerol, propylene glycol, triethylene glycol monomethyl ether, triethanolamine, Proxel XL-2(S) (Lonza), and deionized water in the specified proportions, and the ingredients were mixed and stirred for 2 hours with a magnetic stirrer. The stirred mixture was filtered through a 1-μm membrane filter.

### Examples LC2 to LC6

Ink jet ink compositions were prepared as in Example LC1, except that the percentages of the ingredients were changed according to the formula presented in Table 2.

### Comparative Examples LC1 and LC2

Ink jet ink compositions were prepared as in Example LC1, except that the percentages of the ingredients were changed according to the formula presented in Table 2.

### Comparative Examples LC3 and LC4

Ink jet ink compositions were prepared as in Example LC1, except that the SILFACE SAG503A (Nissin Chemical Industry) silicone surfactant was replaced with BYK-348 (BYK Chemie), and the percentages of the ingredients were changed according to the formula presented in Table 2.

In the above Examples and Comparative Examples, SILFACE SAG503A (Nissin Chemical Industry) and BYK-348 (BYK Chemie) silicone surfactants were used. Their cloud point was measured as follows. That is, a mixture of 99.0 parts by mass of a 10% by mass aqueous solution of propylene glycol and 1.0 part by mass of the silicone surfactant was stirred for 1 hour with a magnetic stirrer, and the resulting liquid mixture was sealed in 100-mL vials in 30-mL aliquots. The range of temperatures at which the oil component separates and makes the composition turbid was measured by leaving the vials in temperature-controlled chambers at 40° C., 50° C., and 60° C. for 24 hours. SILFACE SAG503A (Nissin Chemical Industry) did not become turbid even at 60° C., indicating its cloud point is higher than 60° C. BYK-348 (BYK Chemie) became turbid at 60° C. and 50° C., indicating its cloud point is 50° C. or below.

The formula of the ink jet ink compositions prepared in the Examples and Comparative Examples is summarized in Tables 1 and 2. In Tables 1 and 2, the percentages of the ingredients are in % by mass. “DR60” represents C.I. Disperse Red 60, “DB359” represents C.I. Disperse Blue 359, “SAG503A” represents SILFACE SAG503A (Nissin Chemical Industry), “BYK-348” represents BYK-348 (BYK Chemie), “GL” represents glycerol, “PG” represents propylene glycol, “TGME” represents triethylene glycol monomethyl ether, “TEA” represents triethanolamine, and “XL-2” represents Proxel XL-2(S) (Lonza). All ink jet ink compositions of the Examples had a surface tension of 23 mN/m or more and 30 mN/m or less as measured by the Wilhelmy method at 25° C. using a surface tensiometer (Kyowa Interface Science CBVP-7). All ink jet ink compositions of the Examples, furthermore, had a viscosity at 25° C. of 4 mPa·s or more and 6 mPa·s or less as measured using a vibrational viscometer (Sekonic VM-100) as per JIS Z 8809.

TABLE 1

| | | | Dispersant | | | | | | | | |
|---|---|---|---|---|---|---|---|---|---|---|---|
| | | | Sulfonated | | | | | | pH-adjusting | | |
| | Disperse dye | | naphthalene | Surfactant | | Organic solvents | | | agent | Preservative | |
| | DR60 | DB359 | Na condensate | SAG503A | BYK-348 | GL | PG | TGME | TEA | XL2 | Water |
| Example LM1 | 1.0 | — | 1.0 | 0.8 | — | 20.0 | 10.0 | 3.0 | 0.5 | 0.2 | 63.5 |
| Example LM2 | 1.25 | — | 1.25 | 0.8 | — | 20.0 | 10.0 | 3.0 | 0.5 | 0.2 | 63.0 |
| Example LM3 | 1.5 | — | 1.5 | 0.8 | — | 20.0 | 10.0 | 3.0 | 0.5 | 0.2 | 62.5 |
| Example LM4 | 1.75 | — | 1.75 | 0.8 | — | 20.0 | 10.0 | 3.0 | 0.5 | 0.2 | 62.0 |
| Example LM5 | 2.0 | — | 2.0 | 0.8 | — | 20.0 | 10.0 | 3.0 | 0.5 | 0.2 | 61.5 |
| Example LM6 | 3.0 | — | 3.0 | 0.8 | — | 20.0 | 7.0 | 3.0 | 0.5 | 0.2 | 62.5 |
| Comparative | 0.5 | — | 0.5 | 0.8 | — | 20.0 | 10.0 | 3.0 | 0.5 | 0.2 | 64.5 |
| Example LM1 | | | | | | | | | | | |
| Comparative | 0.75 | — | 0.75 | 0.8 | — | 20.0 | 10.0 | 3.0 | 0.5 | 0.2 | 64.0 |
| Example LM2 | | | | | | | | | | | |
| Comparative | 1.5 | — | 1.5 | — | 0.8 | 20.0 | 10.0 | 3.0 | 0.5 | 0.2 | 62.5 |
| Example LM3 | | | | | | | | | | | |
| Comparative | 1.75 | — | 1.75 | — | 0.8 | 20.0 | 10.0 | 3.0 | 0.5 | 0.2 | 62.0 |
| Example LM4 | | | | | | | | | | | |

TABLE 2

| | | | Dispersant | | | | | | | | |
|---|---|---|---|---|---|---|---|---|---|---|---|
| | | | Sulfonated | | | | | | pH-adjusting | | |
| | Disperse dye | | naphthalene | Surfactant | | Organic solvents | | | agent | Preservative | |
| | DR60 | DB359 | Na condensate | SAG503A | BYK-348 | GL | PG | TGME | TEA | XL2 | Water |
| Example LC1 | — | 1.0 | 1.0 | 0.8 | — | 20.0 | 10.0 | 3.0 | 0.5 | 0.2 | 63.5 |
| Example LC2 | — | 1.25 | 1.25 | 0.8 | — | 20.0 | 10.0 | 3.0 | 0.5 | 0.2 | 63.0 |
| Example LC3 | — | 1.5 | 1.5 | 0.8 | — | 20.0 | 10.0 | 3.0 | 0.5 | 0.2 | 62.5 |
| Example LC4 | — | 1.75 | 1.75 | 0.8 | — | 20.0 | 10.0 | 3.0 | 0.5 | 0.2 | 62.0 |
| Example LC5 | — | 2.0 | 2.0 | 0.8 | — | 20.0 | 10.0 | 3.0 | 0.5 | 0.2 | 61.5 |
| Example LC6 | — | 3.0 | 3.0 | 0.8 | — | 20.0 | 7.0 | 3.0 | 0.5 | 0.2 | 62.5 |
| Comparative | — | 0.5 | 0.5 | 0.8 | — | 20.0 | 10.0 | 3.0 | 0.5 | 0.2 | 64.5 |
| Example LC1 | | | | | | | | | | | |
| Comparative | — | 0.75 | 0.75 | 0.8 | — | 20.0 | 10.0 | 3.0 | 0.5 | 0.2 | 64.0 |
| Example LC2 | | | | | | | | | | | |
| Comparative | — | 1.25 | — | — | 0.8 | 20.0 | 10.0 | 3.0 | 0.5 | 0.2 | 64.25 |
| Example LC3 | | | | | | | | | | | |
| Comparative | — | 1.5 | — | — | 0.8 | 20.0 | 10.0 | 3.0 | 0.5 | 0.2 | 64.0 |
| Example LC4 | | | | | | | | | | | |

### 6. Preparation of Dark Inks

### Preparation Example DM1

A magenta ink (dark ink) having the formula given in Table 3 was prepared. First, a mixture of 15 parts by mass of C.I. Disperse Red 60 (disperse dye), 15 parts by mass of a sulfonated naphthalene-formaldehyde condensate (dispersant), and 70 parts by mass of deionized water was stirred until it became a slurry.

This slurry was put into a mixing tank of a bead mill, and the dye was dispersed with 0.3-mm zirconia beads to a specific surface area of the disperse dye of 3.0 m²/g. The amount of the beads was 80% by volume of the milling chamber.

To the resulting liquid dispersion of disperse dye were added SILFACE SAG503A (Nissin Chemical Industry) silicone surfactant, glycerol, propylene glycol, triethylene glycol monomethyl ether, triethanolamine, Proxel XL-2(S) (Lonza), and deionized water in the specified proportions, and the ingredients were mixed and stirred for 2 hours with a magnetic stirrer. The stirred mixture was filtered through a 1-μm membrane filter.

### Preparation Examples DM2 to DM6

dark inks were prepared as in Preparation Example DM1, except that the percentages of the ingredients were changed according to the formula presented in Table 3.

### Preparation Example DC1

A cyan ink (dark ink) having the formula given in Table 3 was prepared. First, a mixture of 15 parts by mass of C.I. Disperse Blue 359 (disperse dye), 15 parts by mass of a sulfonated naphthalene-formaldehyde condensate (dispersant), and 70 parts by mass of deionized water was stirred until it became a slurry.

This slurry was put into a mixing tank of a bead mill, and the dye was dispersed with 0.3-mm zirconia beads to a specific surface area of the disperse dye of 3.0 m²/g. The amount of the beads was 80% by volume of the milling chamber.

To the resulting liquid dispersion of disperse dye were added SILFACE SAG503A (Nissin Chemical Industry) silicone surfactant, glycerol, propylene glycol, triethylene glycol monomethyl ether, triethanolamine, Proxel XL-2(S) (Lonza), and deionized water in the specified proportions, and the ingredients were mixed and stirred for 2 hours with a magnetic stirrer. The stirred mixture was filtered through a 1-μm membrane filter.

### Preparation Examples DC2 to DC5

dark inks were prepared as in Preparation Example DC1, except that the percentages of the ingredients were changed according to the formula presented in Table 3.

The formula of the dark inks prepared in the Preparation Examples is summarized in Table 3. In Table 3, the percentages of the ingredients are in % by mass. “DR60” represents C.I. Disperse Red 60, “DB359” represents C.I. Disperse Blue 359, “SAG503A” represents SILFACE SAG503A (Nissin Chemical Industry), “BYK-348” represents BYK-348 (BYK Chemie), “GL” represents glycerol, “PG” represents propylene glycol, “TGME” represents triethylene glycol monomethyl ether, “TEA” represents triethanolamine, and “XL-2” represents Proxel XL-2(S) (Lonza). All ink jet ink compositions of the Preparation Examples had a surface tension of 23 mN/m or more and 30 mN/m or less as measured by the Wilhelmy method at 25° C. using a surface tensiometer (Kyowa Interface Science CBVP-7). All ink jet ink compositions of the Preparation Examples, furthermore, had a viscosity at 25° C. of 4 mPa·s or more and 6 mPa·s or less as measured using a vibrational viscometer (Sekonic VM-100) as per JIS Z 8809.

TABLE 3

| | | | Dispersant | | | | | | | | |
|---|---|---|---|---|---|---|---|---|---|---|---|
| | | | Sulfonated | | | | | | pH-adjusting | | |
| | Disperse dye | | naphthalene | Surfactant | | Organic solvents | | | agent | Preservative | |
| | DR60 | DB359 | Na condensate | SAG503A | BYK-348 | GL | PG | TGME | TEA | XL2 | Water |
| Preparation | 5.0 | — | 5.0 | 0.8 | — | 20.0 | 5.0 | 3.0 | 0.5 | 0.2 | 60.5 |
| Example DM1 | | | | | | | | | | | |
| Preparation | 5.5 | — | 5.5 | 0.8 | — | 20.0 | 5.0 | 3.0 | 0.5 | 0.2 | 59.5 |
| Example DM2 | | | | | | | | | | | |
| Preparation | 6.0 | — | 6.0 | 0.8 | — | 17.5 | 5.0 | 3.0 | 0.5 | 0.2 | 61.0 |
| Example DM3 | | | | | | | | | | | |
| Preparation | 6.5 | — | 6.5 | 0.8 | — | 15.0 | 5.0 | 3.0 | 0.5 | 0.2 | 62.5 |
| Example DM4 | | | | | | | | | | | |
| Preparation | 7.0 | — | 7.0 | 0.8 | — | 15.0 | 5.0 | 3.0 | 0.5 | 0.2 | 61.5 |
| Example DM5 | | | | | | | | | | | |
| Preparation | 8.0 | — | 8.0 | 0.8 | — | 15.0 | 5.0 | 3.0 | 0.5 | 0.2 | 59.5 |
| Example DM6 | | | | | | | | | | | |
| Preparation | — | 3.5 | 3.5 | 0.8 | — | 20.0 | 5.0 | 3.0 | 0.5 | 0.2 | 63.5 |
| Example DC1 | | | | | | | | | | | |
| Preparation | — | 4.0 | 4.0 | 0.8 | — | 20.0 | 5.0 | 3.0 | 0.5 | 0.2 | 62.5 |
| Example DC2 | | | | | | | | | | | |
| Preparation | — | 4.5 | 4.5 | 0.8 | — | 20.0 | 5.0 | 3.0 | 0.5 | 0.2 | 61.5 |
| Example DC3 | | | | | | | | | | | |
| Preparation | — | 5.0 | 5.0 | 0.8 | — | 17.5 | 5.0 | 3.0 | 0.5 | 0.2 | 63.0 |
| Example DC4 | | | | | | | | | | | |
| Preparation | — | 6.0 | 6.0 | 0.8 | — | 15.0 | 5.0 | 3.0 | 0.5 | 0.2 | 63.5 |
| Example DC5 | | | | | | | | | | | |

### 7. Testing

The light inks (ink jet ink compositions) of the Examples and Comparative Examples were tested as follows.

### 7-1. Sedimentation

The light inks (ink jet ink compositions) of the Examples and Comparative Examples were tested for sedimentation. First, the absorbance of the freshly prepared light ink was measured at the maximum absorption wavelength (absorbance W0).

Then 100 mL of the light ink was put into a predetermined glass vial, and this vial was left in a temperature-controlled chamber at 60° C. for 5 days and then in a room at 25° C. for 3 weeks. The absorbance of a 5-mL sample of the supernatant was then measured at the maximum absorption wavelength (absorbance WA).

From the absorbance measurements W0 and WA the percentage of remaining (dissolved) disperse dye S was determined, and resistance to sedimentation was graded according to the criteria below. The ink composition is more resistant to sedimentation with higher percentages S, and grades A and B indicate good levels of sedimentation resistance.

Percentage of remaining (dissolved) dye S (%)=((Absorbance WA)/(Absorbance W0)×100

A: The percentage S is 90% or more.

B: The percentage S is 80% or more and less than 90%.

C: The percentage S is less than 80%.

### 7-2. Storage Stability

The light inks (ink jet ink compositions) of the Examples and Comparative Examples were tested for stability when stored. First, only 10 mL of the light ink was put into a predetermined glass vial, and this vial was left in a 30° C. to 60° C. environment for seven cycles, a total of 168 hours, with the gas-liquid interface present. Then the light ink was filtered through a 10-μm metal mesh filter, and the number of remaining solid particles per mm² of the filter was counted. Storage stability was graded according to the criteria below. The ink composition is more stable when stored with less solid particles on the metal mesh filter, and grades A and B indicate good levels of storage stability.

A: The number of solid particles per mm² is less than 5.

B: The number of solid particles per mm² is 5 or more and less than 30.

C: The number of solid particles per mm² is 30 or more.

### 7-3. Graininess

Recordings were produced using the light inks (ink jet ink compositions) of Examples LM1 to LM6 and Comparative Examples LM1 to LM4 as follows, and the resulting recordings were tested for graininess.

First, the light ink was loaded into a tank of an ink jet recording apparatus constructed as in FIGS. 1 to 7.

Then gradations from white to a 100% duty of magenta were printed on a sheet of TRANSJET Classic (Cham Paper; intermediate transfer medium) at a resolution of 720×720 dpi by ejecting the ink through an ejection head of the ink jet recording apparatus. A 100% duty means applying the ink at full capacity of the apparatus.

The inked side of the intermediate transfer medium was attached to fabric in white (100% polyester; Amiina, Toray; recording medium), and the ink was sublimated and transferred to the fabric by heating the paper at 200° C. for 60 seconds using a heat press (TP-608M, Taiyo-Seiki). In this way, a dyed article (recording) was obtained.

Another set of dyed articles (recordings) were produced in the same way, except that gradations from white to a 100% duty of cyan were printed using the light inks (ink jet ink compositions) of Examples LC1 to LC6 and Comparative Examples LC1 to LC4.

The printed side of the dyed articles was visually inspected, and graininess was graded according to the criteria below. Grades A and B indicate good levels of graininess.

A: Graininess is unrecognizable from 30 cm away.

B: Graininess is recognizable from 30 cm away.

C: Graininess is recognizable even from more than 30 cm away.

### 7-4. Color Matching

The light inks (ink jet ink compositions) of the Examples and Comparative Examples were combined with dark inks. Recordings were produced using the resulting ink jet ink sets as follows, and the resulting recordings were tested for color matching.

First, the light inks containing C.I. Disperse Red 60 and the dark inks containing C.I. Disperse Red 60 were combined into ink jet ink sets, each consisting of two ink jet ink compositions. Likewise, the light inks containing C.I. Disperse Blue 359 and the dark inks containing C.I. Disperse Blue 359 were combined into ink jet ink sets, each consisting of two ink jet ink compositions.

Then the light and dark inks in each ink jet ink set were applied to a sheet of TRANSJET Classic (Cham Paper; intermediate transfer medium) at a resolution of 720×720 dpi using an ink jet recording apparatus constructed as in FIGS. 1 to 7. A pattern of solid images from 10% to 50% duties was printed with the dark ink, and another pattern of solid images from 10% to 50% duties was printed with the light ink.

The inked side of the intermediate transfer medium was attached to fabric in white (100% polyester; Amiina, Toray; recording medium), and the ink was sublimated and transferred to the fabric by heating the paper at 200° C. for 60 seconds using a heat press (TP-608M, Taiyo-Seiki). In this way, a dyed article (recording) was obtained.

The printed side of the dyed articles was analyzed using a spectrodensitometer (trade name “FD-7,” Konica Minolta) with illuminant D65 and an observer angle of 2°. a* and b* were calculated, and color matching was graded according to the criteria below. Grade A indicates a good level of color matching.

A: The course of changes in the (a*, b*) of the light ink agrees with that in the (a*, b*) of the dark ink.

C: The course of changes in the (a*, b*) of the light ink disagrees with that in the (a*, b*) of the dark ink.

The results of tests 7-1 to 7-3 are summarized in Table 4. The results of test 7-4 are summarized in Tables 5 and 6.

TABLE 4

| | | Storage | |
|---|---|---|---|
| | Sedimentation | stability | Graininess |
| Example LM1 | B | B | A |
| Example LM2 | A | A | A |
| Example LM3 | A | A | A |
| Example LM4 | A | A | A |
| Example LM5 | A | A | B |
| Example LM6 | A | A | C |
| Comparative Example LM1 | C | C | A |
| Comparative Example LM2 | C | C | A |
| Comparative Example LM3 | A | C | A |
| Comparative Example LM4 | A | C | A |
| Example LC1 | B | A | A |
| Example LC2 | A | A | A |
| Example LC3 | A | A | A |
| Example LC4 | A | A | B |
| Example LC5 | A | A | B |
| Example LC6 | A | A | C |
| Comparative Example LC1 | C | C | A |
| Comparative Example LC2 | C | B | A |
| Comparative Example LC3 | A | C | A |
| Comparative Example LC4 | A | C | B |

TABLE 5

| | Comparative | Comparative | | | | | | |
|---|---|---|---|---|---|---|---|---|
| | Example | Example | Example | Example | Example | Example | Example | Example |
| | LM1 | LM2 | LM1 | LM2 | LM3 | LM4 | LM5 | LM6 |
| Preparation | C | C | A | A | A | A | A | A |
| Example DM1 | | | | | | | | |
| Preparation | C | C | C | A | A | A | A | A |
| Example DM2 | | | | | | | | |
| Preparation | C | C | C | A | A | A | A | A |
| Example DM3 | | | | | | | | |
| Preparation | C | C | C | A | A | A | A | A |
| Example DM4 | | | | | | | | |
| Preparation | C | C | C | C | A | A | A | A |
| Example DM5 | | | | | | | | |
| Preparation | C | C | C | C | A | A | A | A |
| Example DM6 | | | | | | | | |

TABLE 6

| | Comparative | Comparative | | | | | | |
|---|---|---|---|---|---|---|---|---|
| | Example | Example | Example | Example | Example | Example | Example | Example |
| | LC1 | LC2 | LC1 | LC2 | LC3 | LC4 | LC5 | LC6 |
| Preparation | C | A | A | A | A | A | A | A |
| Example DC1 | | | | | | | | |
| Preparation | C | A | A | A | A | A | A | A |
| Example DC2 | | | | | | | | |
| Preparation | C | C | A | A | A | A | A | A |
| Example DC3 | | | | | | | | |
| Preparation | C | C | A | A | A | A | A | A |
| Example DC4 | | | | | | | | |
| Preparation | C | C | C | A | A | A | A | A |
| Example DC5 | | | | | | | | |

As is clear from Tables 4 to 6, the inks of the Examples achieved good results. With the inks of the Comparative Examples, the results were unsatisfactory.

The prepared inks were also combined into ink jet ink sets consisting of four inks: a light ink containing C.I. Disperse Red 60, a dark ink containing C.I. Disperse Red 60, a light ink containing C.I. Disperse Blue 359, and a dark ink containing C.I. Disperse Blue 359. Recordings were produced by printing a predetermined pattern of images with these ink jet ink sets using an ink jet recording apparatus constructed as in FIGS. 1 to 7. With the ink jet ink sets that included a light ink of an Example, the images on the resulting recording were good, or achieved a high degree of color matching, throughout. With the ink jet ink sets that included only light inks of Comparative Examples, the results were unsatisfactory.

What is claimed is:

1. An ink jet ink composition comprising:
at least one disperse dye;
a silicone surfactant; and
water, wherein:
a disperse dye content is 1.0% by mass or more and 3.0% by mass or less; and
when 1.0 part by mass of the silicone surfactant and 99.0 parts by mass of a 10% by mass aqueous solution of propylene glycol are mixed to give a mixture, the mixture has a cloud point of 60° C. or above.

2. The ink jet ink composition according to claim 1, further comprising:
at least one dispersant.

3. The ink jet ink composition according to claim 2, wherein:
the dispersant is one or more selected from the group consisting of sodium salts of sulfonated naphthalene-formaldehyde condensates and sodium salts of lignosulfonates.

4. The ink jet ink composition according to claim 1, wherein:
the disperse dye is one or more selected from the group consisting of C.I. Disperse Red 60 and C.I. Disperse Blue 359.

5. The ink jet ink composition according to claim 1, wherein:
the disperse dye content is 2.0% by mass or less.

6. The ink jet ink composition according to claim 1, wherein:
a silicone surfactant content is 0.1% by mass or more and 3.0% by mass or less.

7. An ink jet ink set comprising:
a plurality of ink jet ink compositions, wherein:
at least one of the ink jet ink compositions is the ink jet ink composition according to claim 1.

8. The ink jet ink set according to claim 7, wherein:
two or more of the ink jet ink compositions are the ink jet ink compositions according to claim 1.

9. The ink jet ink set according to claim 7, wherein:
the ink jet ink compositions include at least one light ink being the ink jet ink composition or compositions according to claim 1; and at least one dark ink containing the same disperse dye as the light ink and a higher concentration of the disperse dye than the light ink.

10. The ink jet ink set according to claim 9, wherein:
the dark ink is at least one ink including cyan ink; and
a disperse dye content of the cyan ink is 3.5% by mass or more and 6.0% by mass or less.

11. The ink jet ink set according to claim 10, wherein:
0.18≤XLC/XDC≤0.70,
where XDC is the disperse dye content in % by mass of the cyan ink, and XLC is a disperse dye content in % by mass of the light ink that contains the same disperse dye as the cyan ink.

12. The ink jet ink set according to claim 9, wherein:
the dark ink is at least one ink including magenta ink; and
a disperse dye content of the magenta ink is 5.0% by mass or more and 8.0% by mass or less.

13. The ink jet ink set according to claim 12, wherein:
0.18≤XLM/XDM≤0.70,
where XDM is the disperse dye content in % by mass of the magenta ink, and XLM is a disperse dye content in % by mass of the light ink that contains the same disperse dye as the magenta ink.

14. An ink jet recording apparatus comprising:
the ink jet ink composition according to claim 1.
